(19) United States
(12) Patent Application Publication
(10) Pub. No.: US 2010/0081488 A1
(43) Pub. Date: Apr. 1, 2010

(54) PORTABLE WIRELESS COMMUNICATION DEVICE

(76) Inventor: Justin C. Kim, Great Neck, NY (US)

Correspondence Address: GREENBERG TRAURIG, LLP, 200 PARK AVE., P.O. BOX 677, FLORHAM PARK, NJ, 07932, US

(21) Appl. No.: 12/238,651

(22) Filed: Sep. 26, 2008

(51) Int. Cl. H04M 1/00

(52) U.S. Cl. 455/575.2

(57) ABSTRACT

A communication device includes a portable housing and a processor housed in the housing. The processor is configured to receive first signals from an external audio player. A transmitter is housed in the housing for wirelessly transmitting second signals to an external receiver in accordance with a first communication protocol such that sounds corresponding to the second signals can be produced through a speaker system of the external receiver. A communication module is also housed in the housing for wirelessly communicating with a wireless phone in accordance with a second communication protocol such that third signals associated with a phone call can be transmitted between the wireless phone and the processor. The device is provided with a headset having a microphone and an earpiece. The headset is configured so as to be connected to the processor such that the phone call can be made through the wireless phone with the use of the headset.

### RELATED APPLICATION

This application is being filed concurrently with U.S. Non-provisional Patent Application Ser. No. ______ entitled “PORTABLE WIRELESS COMMUNICATION DEVICE” (Inventor Justin C. Kim; Attorney Docket No. 102655.010700), the entire disclosure of which is incorporated herein by reference.

### FIELD OF THE INVENTION

The present invention relates to wireless devices for use with multimedia players and communications units, and, more particularly, to wireless multi-protocol electronic devices that integrate the broadcast of multimedia playback signals with the hands free operation of wireless communication units.

### BACKGROUND OF THE INVENTION

Cellular phones, portable digital multimedia players (e.g., MP3 players) and products that combine these units have been available for some time. Devices are also available that enhance the operation and functionality of such products. For example, headpieces that use the Bluetooth protocol are available to wirelessly connect with cellular phones to facilitate the hands-free operation of the cellular phones. Likewise, devices are available that use frequency modulation (FM) wireless protocol to broadcast multimedia playback signals to multimedia devices, such as automobile FM radio receivers.

### SUMMARY OF THE INVENTION

The present invention relates to a communication device having a portable housing and a processor which is housed in the housing and which is configured to receive first signals from an external audio player. A transmitter is housed in the housing for wirelessly transmitting second signals to an external receiver in accordance with a first communication protocol such that sounds corresponding to the second signals can be produced through a speaker system of the external receiver. A communication module is also housed in the housing for wirelessly communicating with a wireless phone in accordance with a second communication protocol such that third signals associated with a phone call can be transmitted between the wireless phone and the processor. The device is provided with a headset having a microphone and an earpiece. The headset is configured so as to be connected to the processor such that the phone call can be made through the wireless phone with the use of the headset.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a schematic block diagram of a device according to an embodiment of the present invention, the device shown in connection with other electronic devices;

FIG. 2A is a front elevational view of the device shown in FIG. 1;

FIG. 2B is a top plan view of the device shown in FIG. 1;

FIG. 2C is a bottom plan view of the device shown in FIG. 1;

FIG. 2D is a left-side elevational view of the device shown in FIG. 1;

FIG. 2E is a right-side elevational view of the device shown in FIG. 1; and

FIG. 3 is a schematic block diagram illustrating various components of the device shown in FIG. 1.

### DETAILED DESCRIPTION OF THE INVENTION

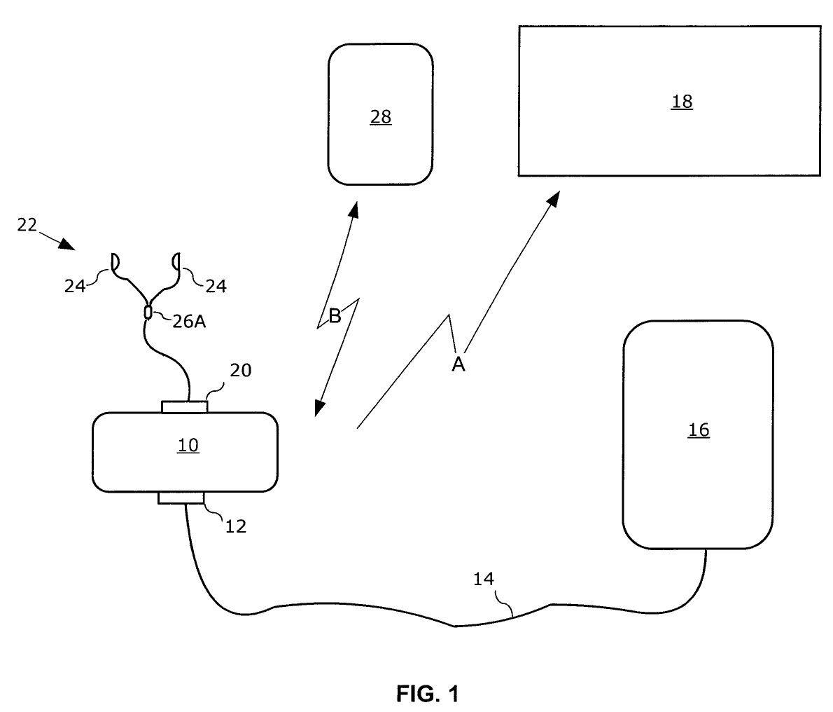

FIG. 1 illustrates a device 10 constructed in accordance with an exemplary embodiment of the present invention. The device 10 is adapted for use in conjunction with a variety of electronic units to improve the ease of use of the electronic units. More particularly, the device 10 includes a socket or connector 12 (e.g., mini 8 pin socket for 30 pin—8 pin cable connector) for removably connecting the device 10 to a cable 14 that can be attached to a conventional multimedia player 16 (e.g., an MP3 player, such as iPOD® devices, or cellular phones having audio playback functions, such as phones sold under the trademark iphone). The device 10 can, when connected to the player 16 via the cable 14, receive and optionally process audio signals from the player 16 (hereinafter “playback signals”) and then wirelessly transmit or broadcast the playback signals (as indicated by arrow A in FIG. 1) to a multimedia receiver 18 (e.g., an FM radio receiver) with the use of a first wireless modulation protocol (e.g., frequency modulation (FM) from 87.5 MHz to 107.9 MHz) for playback through the receiver 18 (e.g., through its speaker system).

Still referring to FIG. 1, the device 10 includes a socket 20 or connector (e.g., a 3.5phi stereo earphone socket) for removably connecting to a headset 22 having earpieces 24 and a microphone 26A. The device 10 is adapted to wirelessly communicate with a cellular phone 28 through the use of a second wireless modulation protocol, such as Bluetooth with HFP and HSP profiles, (as indicated by arrow B in FIG. 1) to transmit/receive signals to and from the cellular phone 28, for allowing a user to make hands-free cellular phone calls from/to the cellular phone 28 via the headset 22.

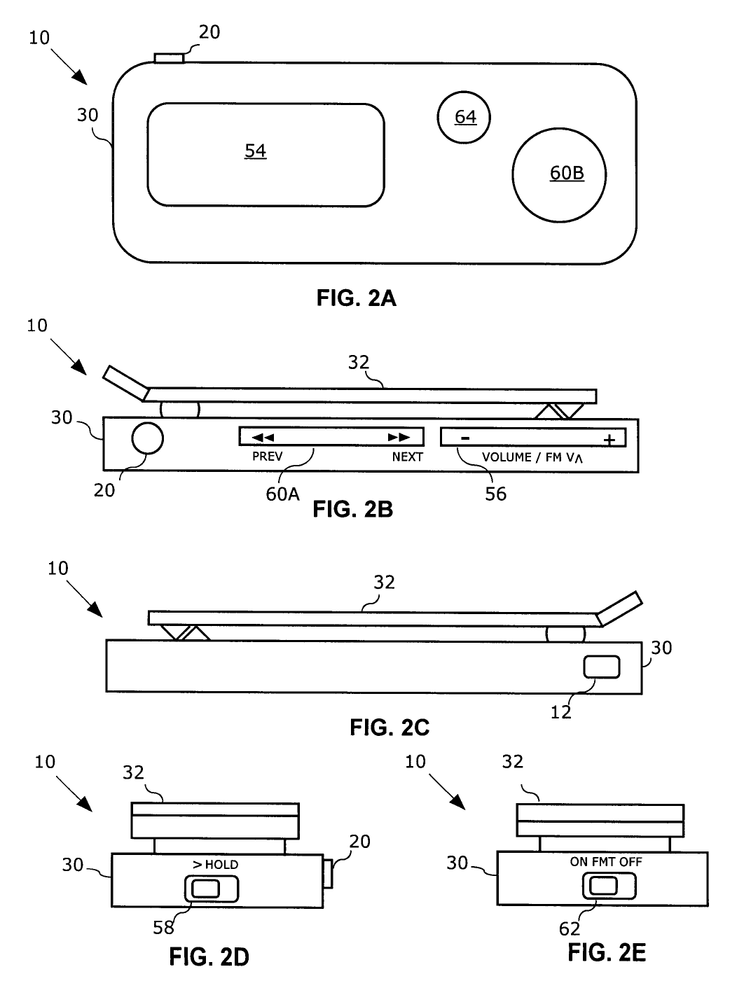

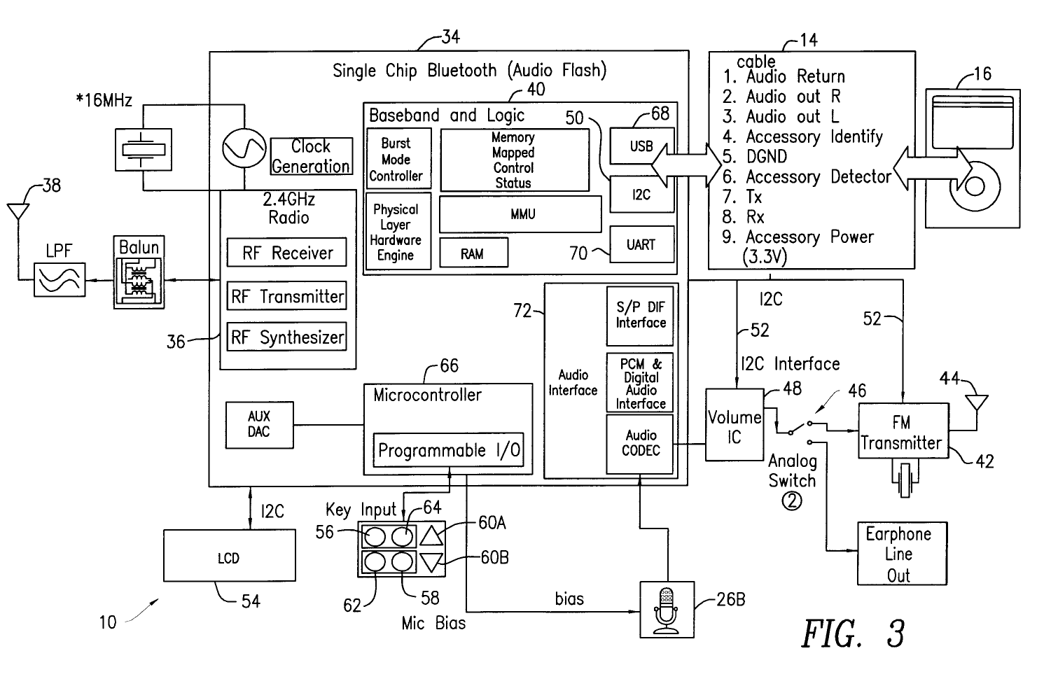

Referring now to FIGS. 2A-2E and 3, the device 10 has a portable housing 30, which may also have a clip 32 mounted thereon for removably fastening the device 10 to an object such as an article of clothing or a seatbelt of a car (not shown). The housing 30 encloses therewithin a digital signal processing engine (hereinafter “the processor”) 34. The processor 34 includes a transceiver 36 (e.g., a 2.4GHz radio for operation on the second wireless modulation protocol) and an antenna 38 for communicating with the cellular phone 28. The processor 34 also includes a baseband and logic module 40 that supports the operation of the device 10 and the processing of signals received from/transmitted to the player 16 and/or the cellular phone 28 in conventional manners.

Referring specifically to FIG. 3, the device 10 also has a transmitter 42 that is positioned in the housing 30 of the device 10 and which is connected to an antenna 44. The antenna 44 may be positioned outside or inside the housing 30 (e.g., incorporated within the cable 14). The transmitter 42 and antenna 44 are adapted to broadcast in accordance with the first communication protocol the playback signals received from the player 16 and optionally processed by the processor 34 in a conventional manner. The receiver 18 receives the signals transmitted from the transmitter 42 and the antenna 44 and plays them back on its the speaker system.

An analog switch 46 may be connected to a volume controller 48 for connecting the output of the volume controller 48 to the transmitter 42 when the headset 22 is not inserted in the socket 20, or to the headset 22, when the headset 22 is plugged into the socket 20. In the absence of the headset 22 connected to the device 10, hands-free phone calls may be conducted with the use of a microphone 26B, which may be positioned/integrated with the device 10 and the receiver 18. In this instance, cellular phone signals received by the device 10 (i.e., via the second wireless modulation protocol, e.g., Bluetooth) are simultaneously re-transmitted via the first wireless protocol to the receiver 18 for reproduction of the received cellular phone signals on its speakers (i.e., as opposed to the reproduction of the received cellular phone signals on the earpieces 24 of the headset 22).

Continuing to refer to FIGS. 2A-2E and FIG. 3, the processor 34 also has an I2C interface 50 that is connected to an I2C bus 52 for facilitating the communication of control data signals between various elements of the processor 34. For instance, user-interface elements such as an LCD display 54, a “volume/FMT-+” switch 56 (i.e., for volume control, FM frequency adjustment and saving favorite stations), a call “hold” switch 58, a “previous/next” switch 60A (i.e., for selecting player 16 media), a “pause/play” button 60B, a “FMT on off” switch 62 (i.e., for turning the FM transmitter 42 on or off), and a “cellular” button 64 (i.e., for Bluetooth pairing the device 10 with the cellular phone 28, and answering, transferring, redialing or ending calls) are all positioned on the housing 30 of the device 10 (see FIGS. 2A-2E) and are all connected to the I2C bus 52. In this regard, the processor 34 also includes a microcontroller 66 for processing signals received from/sent to the aforesaid user-interface elements via the I2C bus 52. A USB interface 68 is also provided in the processor 34 for supporting USB interconnection with the player 16 (e.g., powering the device 10 from the player 16, etc.). Moreover, the processor 34 includes a UART interface 70 that is connected to the socket 12 for allowing control data exchange with the player 16. The processor 34 is provided with an audio interface 72 that is connected to the microphone 26B and the volume controller 48.

In operation, the user plugs the cable 14 with the player 16 attached thereto into the socket 12 of the device 10. The device 10 may be powered by the player 16 in a conventional way. The user may attach the device 10 to an article such as a seatbelt of a car (not shown) by clasping the clip 32 thereonto. When the user places the switch 62 to the “FMT on” position, the user may control the operation of the player 16 by operating the “volume/FMT-+” switch 56, the “previous/next” switch 60A, and the “pause/play” button 60B. User generated signals produced by operating the buttons and switches are transmitted to the microcontroller 66 of the processor 34 through the I2C bus 52 for processing by the microcontroller 66. Control signals generated by the processor 34 are conveyed to the player 16 via the UART interface 70 over the cable 14.

Playback signals (e.g., stereo audio music) generated by the player 16 are transmitted through the processor 34 to the transmitter 42 over the I2C bus 52 for broadcast via the first wireless communication protocol through the antenna 44. The processor 34 may process the playback signals before they are transmitted to the transmitter 42. The signals broadcast through the antenna 44 are received by the receiver 18 and played back through its speaker system. Alternately, when the headset 22 is plugged into the socket 20 of the device 10, the analog switch 46 diverts the output of the volume controller 48 from the transmitter 42 to the headset 22 for playback of the playback signals through the earpieces 24 of the headset 22.

When the user places the switch 62 on the “FMT OFF” position, the device 10 is able to communicate, via the second wireless communications protocol, with a Bluetooth enabled cellular phone 28. More particularly, when the device 10 is paired with the cellular phone 28 by pressing the “cellular” button 64 until the button 64 indicates that paring has occurred, a cellular phone call may be accepted, transferred or rejected by the user remotely (i.e., without directly using the cellular phone). For instance, signals associated with an incoming or outgoing phone call on the cellular phone 28 can be received by the antenna 38 and processed by the transceiver 36 of the processor 34 in a conventional manner. Caller identification information (CID) may also be conveyed (i.e., if CID is provided by the cellular network provider) to the LCD display 54 via the I2C bus 52. The user may, upon examining the CID, press the “cellular” button 64 to accept an incoming call. The processor 34 can be configured such that if the incoming call is received during the playback of the player 16, the processor 34 sends a signal to the player 16 to put same in a pause mode. Alternatively, the processor 34 can be configured to pause the transmission of the playback signals from the antenna 14 without putting the player 16 in such a mode.

If the call is accepted, it is connected to the headset 22, by the microcontroller 66, so that the user may hear the call through earpieces 24. When the user speaks, his or her voice is received by the microphone 26A of the headset 22 and converted into voice signals, which, in turn, are transmitted to the processor 34. The voice signals, after processing by the processor 34, are transmitted to the transceiver 36 for broadcasting, through the antenna 38, to the cellular phone 28. The user may place the call on hold by operating the “call hold” switch 58. Outgoing cell phone calls may be initiated from the device 10 by the user by pressing the “cellular” button 64 for voice-activated dialing (i.e., if this function is supported by the cellular phone 28) or for recent-call redialing.

It should be noted that the present invention can have numerous modifications and variations. For instance, an authentication chip may be integrated into the device 10 for support of specific player manufacture's features. In another instance, the device 10 may be adapted to receive the playback signals wirelessly. Also, features and functions may be added or removed from the device 10 by programming the microcontroller 66 of the processor 34.

It will be understood that the embodiment described herein is merely exemplary and that a person skilled in the art may make many variations and modifications without departing from the spirit and scope of the invention. All such variations and modifications, including those discussed above, are intended to be included within the scope of the invention as defined in the appended claims.

What is claimed is:

1. A communication device comprising a portable housing; a processor housed in said housing, said processor being configured to receive first signals from an external audio player; a transmitter housed in said housing for wirelessly transmitting second signals to an external receiver in accordance with a first communication protocol such that sounds corresponding to said second signals can be produced through a speaker system of the external receiver; a communication module housed in said housing for wirelessly communicating with a wireless phone in accordance with a second communication protocol such that third signals associated with a phone call can be transmitted between the wireless phone and said processor; and a headset having a microphone and an earpiece, said headset being configured so as to be connected to said processor such that the phone call can be made through the wireless phone with the use of said headset.

2. The device of claim 1, wherein said housing is sized and shaped so as to be held in a hand of a user.

3. The device of claim 2, wherein said communication module includes a transceiver connected to said processor.

4. The device of claim 3, further comprising a first connector attached to said housing for connection to a cable coupled to the external audio player such that said first signals can be transmitted from the external audio player to said processor through said first connector and the cable.

5. The device of claim 4, further comprising a second connector and a switch housed in said housing, said second connector being configured to be connected to said headset, said switch being connected to said second connector and said transmitter such that said second signals can be transmitted selectively to one of said transmitter and said second connector.

6. The device of claim 5, wherein said second signals include said first signals processed by said processor.

7. The device of claim 5, wherein said second signals include at least some of said third signals processed by said processor.

8. The device of claim 1, wherein said first protocol is a frequency modulation (FM) wireless protocol; and wherein said second protocol is a Bluetooth protocol.

9. The device of claim 1, wherein said second signals include said first signals processed by said processor.

10. The device of claim 1, wherein said processor includes a plurality of user interfaces connected thereto.
